(19) United States
(12) Patent Application Publication
(10) Pub. No.: US 2023/0320439 A1
(43) Pub. Date: Oct. 12, 2023

(54) RESPIRATION-ENHANCEMENT INSERT FOR A FACE MASK TO INCLUDE MEDICAL FACEMASK

(71) Applicant: Robert Goodly, New Orleans, LA (US)

(72) Inventor: Robert Goodly, New Orleans, LA (US)

(21) Appl. No.: 17/953,239

(22) Filed: Sep. 26, 2022

Related U.S. Application Data
(60) Provisional application No. 63/324,039, filed on Mar. 26, 2022.

(51) Int. Cl. A41D 13/11; A62B 23/02

(52) U.S. Cl. CPC A41D 13/1138; A62B 23/025

(57) ABSTRACT

An insert for positioning beneath a facemask includes a front panel having a front surface, a rear surface, two opposing ends and a central aperture. A rear panel is spaced from and attached to the front panel and includes a central aperture aligned with the aperture on the front panel. The space between the front and rear panels defines an exhaust chamber for collecting air exhaled by the wearer. Angularly extending from each end of the front panel is a flap that extends along the side of a wearer’s breathing zone. Extending from each end of the rear flap is an air channel that is in fluid communication with the exhaust chamber. Accordingly, as the wearer exhales, expelled air is collected in the exhaust chamber and flows through the air channels, away from the wearer’s breathing zone.

### RELATED APPLICATION

This application claims benefit to the provisional application US 63/324,039 filed Mar. 26, 2022 and is incorporated here in its entirety.

### BACKGROUND

### Technical Field

This disclosure relates to facemasks. In particular, but without limitation, this disclosure relates to an insert for positioning beneath a conventional facemask having exhaust channels for diverting exhaled air.

When a person speaks, sneezes or coughs, saliva and mucous droplets are projected to the surrounding atmosphere, which are easily inhaled by those nearby. Therefore, a person with a contagious disease can infect a multitude of people during routine interaction.

During an airborne disease pandemic or epidemic, the risk of disease transmission is particularly high whenever a person is in public. For example, during the recent COVID-19 pandemic, most jurisdictions mandated the use of facemasks in public locations to prevent the spread of airborne contaminants. Even in the absence of epidemics, healthcare workers typically wear medical masks and similar face coverings during certain medical procedures to minimize disease transmission. Masks are also worn in certain construction and industrial applications to minimize exposure to dust, debris, and similar airborne contaminants.

However, many resist wearing facemasks because they significantly hinder breathing. Though conventional masks allow a tolerable amount of ambient air intake, they significantly restrict exhaling, thereby exposing the wearer to potentially dangerous levels of carbon dioxide. Overexposure to carbon dioxide can cause hypercapnia and similar medical complications, which can endanger vital organs. A wearer is particularly vulnerable to carbon dioxide overexposure when a mask is worn during vigorous exercise. The inability to adequately expel exhaust air also causes other nuisances, such as fogging eyewear and extreme discomfort.

Accordingly, there is currently a need for a device that facilitates breathing through a protective facemask. The disclosure addresses this need by providing an insert for a medical facemask having exhaust channels for diverting exhaled air away from a wearer’s breathing zone.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### SUMMARY

In an aspect of the disclosure, an insert for positioning beneath a facemask includes a front panel having a front surface, a rear surface, two opposing ends and a central aperture. A rear panel is spaced from and attached to the front panel and includes a central aperture aligned with the aperture on the front panel. The space between the front and rear panels defines an exhaust chamber for collecting air exhaled by the wearer. A flap extends angularly from each end of the front panel and also extends along the side of a wearer’s breathing zone.

Extending from each end of the rear flap is an air channel that is in fluid communication with the exhaust chamber. As the wearer exhales, expelled air is collected in the exhaust chamber and flows through the air channels, away from the wearer’s breathing zone.

In an aspect of the disclosure, an insert may enhance respiration when a user is wearing a facemask.

In another aspect of the disclosure, an insert may divert exhaust gases away from a mask wearer’s breathing zone.

In an aspect of the disclosure, an insert for a medical facemask may be recyclable and biodegradable.

Other systems, methods, features and advantages of the disclosure will be, or will become, apparent to one with skill in the art upon examination of the following figures and detailed description. It is intended that all such additional systems, methods, features and advantages be included within this description, be within the scope of the disclosure, and be protected by the following claims

### BRIEF DESCRIPTION OF THE DRAWINGS

The disclosure can be better understood with reference to the following drawings and description. The components in the figures are not necessarily to scale, emphasis instead being placed upon illustrating the principles of the disclosure. Moreover, in the figures, like referenced numerals designate corresponding parts throughout the different views.

FIGS. 1A and 1B are perspective views of an insert according to the disclosure.

FIGS. 2A and 2B illustrate front and rear plan views of the insert according to the disclosure.

FIG. 3 is a top view of the insert according to the disclosure.

### DETAILED DESCRIPTION

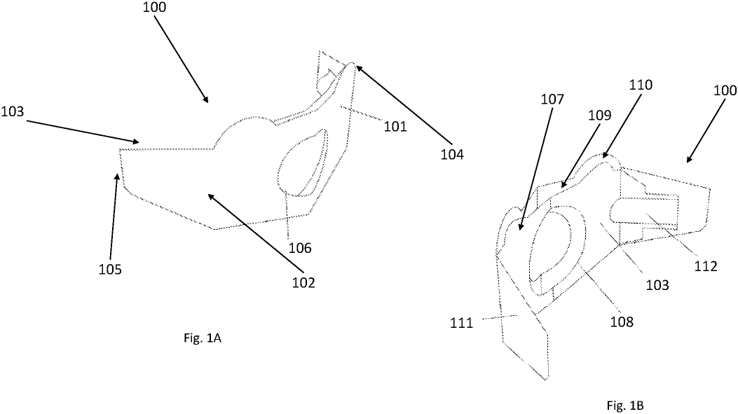

FIGS. 1A and 1B are perspective views of an insert 100 for positioning beneath a facemask to facilitate breathing. In FIG. 1A, the insert 100 includes a front panel 101 having a front surface 102, a rear surface 103, two opposing ends (104, 105) and a central aperture 106. A rear panel 107 is spaced from and attached to the front panel 101 and includes a central aperture 108 aligned with the central aperture 106 on the front panel 101. The space 109 between the front panel 101 and the rear panel 107 defines an exhaust chamber 110 for collecting air exhaled by the wearer.

Angularly extending from each end of the front panel is a flap 111 that extends along the side of a wearer’s breathing zone. Extending from each end of the flap 111 is an air channel 112 that is in fluid communication with the exhaust chamber 110.

Accordingly, to use the above-described device, the insert is positioned behind a facemask with the vent apertures aligned with the wearer’s mouth. The aligned apertures allow the wearer to easily inhale air passing through an overlying facemask and to freely exhale without restriction. As the wearer exhales, expelled air is collected in the exhaust chamber and flows through the air channels, away from the wearer’s breathing zone. The insert 100 may be used in a medical facemask, industrial-use facemask or other applications where exhaustion of air is required for a wearer of a mask.

The insert is preferably constructed with a biodegradable, compostable, recyclable material, such as polylactic acid, that allows the insert to be used multiple times before discarding. The flaps are easily foldable relative to the panels, allowing the insert to be flattened for transport or storage.

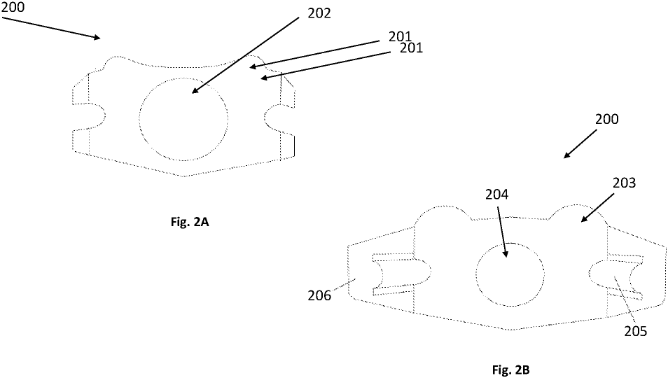

FIGS. 2A and 2B illustrate front and rear plan views of the insert 200 according to the disclosure. In this aspect in FIG. 2A, the front panel 201 and front central aperture 202 may be seen from a front plan view perspective. In the aspect of FIG. 2B, the rear panel 203, the rear central aperture 204, the air channel 205 and the flap 206 may be seen from a rear plan perspective.

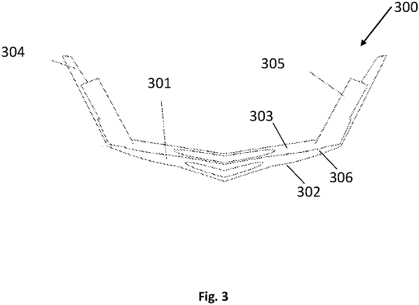

FIG. 3 is a top view of the insert 300 according to the disclosure. In this aspect in FIG. 3, space 301 between the front panel 302 and the rear panel 303 may be seen from a top view perspective. In addition, in one aspect, a flap 304 extends angularly from an end of the rear panel 303. An air channel 305 is disposed upon the rear panel 303 and in fluid communication with an exhaust chamber 306.

While various aspects of the disclosure have been described, it will be apparent to those of ordinary skill in the art that many more aspects and implementations are possible within the scope of the disclosure. Accordingly, the disclosure is not to be restricted except in light of the attached claims and their equivalents.

What is claimed is:

1. A respiration-enhancing apparatus for a facemask, comprising:
An insert positioned beneath the facemask, where the insert comprises:
a front insert panel having a front surface, a rear surface, two opposing ends on either end of the front insert panel and a front insert panel central aperture;
a rear insert panel spaced from and attached to the front insert panel, the rear insert panel comprising a rear insert panel central aperture aligned with the front insert panel aperture, where a space between the front insert panel and the rear insert panel forms an exhaust chamber to collect air exhaled by a wearer.

2. The respiration-enhancing apparatus of claim 1, further comprising a flap that extends angularly from each end of the front insert panel and extending along a side of a wearer’s breathing zone.

3. The respiration-enhancing apparatus of claim 1, where the exhaust chamber is configured to channel the air exhaled by the wearer away from the wearer.

4. The respiration-enhancing apparatus of claim 1, where the facemask comprises a biodegradable material.

5. The respiration-enhancing apparatus of claim 4, where the biodegradable material comprises a biodegradable plastic.

6. The respiration-enhancing apparatus of claim 5, where the biodegradable plastic comprises a polylactic acid.

7. The respiration-enhancing apparatus of claim 1, where the facemask comprises an insert for a medical facemask.

8. The respiration-enhancing apparatus of claim 1, where the insert comprises an insert for an industrial-use facemask.
